(19) United States
(12) Patent Application Publication
(10) Pub. No.: US 2019/0315315 A1
(43) Pub. Date: Oct. 17, 2019

(54) END CAP FOR FLAT WIPER BLADE APPARATUS AND FLAT WIPER BLADE APPARATUS THEREOF

(71) Applicant: KBWS Corporation, Daiseo-gu (KR)

(72) Inventors: Jae Hyuck An, Guji-myeon (KR); Jin Wan Park, Dalseong-gun (KR); Woo Sung Lee, Dalseong-gun (KR); Kwan Hee Kim, Seo-gu (KR)

(21) Appl. No.: 16/377,590

(22) Filed: Apr. 8, 2019

(30) Foreign Application Priority Data
Apr. 16, 2018 (KR) 1020180043798

(51) Int. Cl. B60S 1/38

(52) U.S. Cl. CPC B60S 1/3891; B60S 1/381

(57) ABSTRACT

An end cap for a flat wiper blade apparatus may be provided that includes: a main body which has a cross section corresponding to a cross section of a spoiler member of the flat wiper blade apparatus and surrounds a portion of the spoiler member; a support member which contacts an end portion of the spoiler member and is formed inside the main body across the main body in a width direction; a hook which is formed on one side of the support member and is fastened to an opening of a spring member of the flat wiper blade apparatus; and a protrusion which protrudes from one surface of the support member and by which a portion of a wiper rubber of the flat wiper blade apparatus is caught.

### BACKGROUND

### Field

The present disclosure relates to a flat wiper blade apparatus and more particularly to an end cap for the flat wiper blade apparatus.

### Description of the Related Art

In general, a wiper is installed on the windshield or rear glass of a vehicle. The wiper which plays an important role in obtaining user's visibility by removing snow or rainwater in bad snowy or rainy weather and or by removing impurities on the surface the glass is one of safety devices of the vehicle.

Such a wiper is composed of a wiper arm which performs a reciprocating motion by the driving force of a motor and of a wiper blade which is coupled to the wiper arm and wipes the glass surface. The wiper blade performs a repetitive reciprocating motion in a fan shape as a motor drives a link apparatus connected by the wiper arm. The wiper arm provides pressure which causes the wiper blade to closely contact with the glass in order to remove impurities such as snow, rain, muddy water, etc., on the glass surface.

Recently, attention is being paid to a flat wiper blade apparatus as a wiper. In general, in the flat wiper blade apparatus, a wiper rubber and a spring member are coupled to a spoiler. Additionally, a cover which is referred to as an end cap is installed on both end portions lest the wiper rubber should slide and separate from the spring member.

However, the end cap is assembled to the flat wiper blade apparatus in a vertical direction, which causes the increase of the number of assembling steps.

### DISCLOSURE

### Technical Problem

A purpose of the present invention is designed to overcome the problems of the prior art and is to provide an end cap of a flat wiper blade apparatus, which has a simplified assembly process.

Another purpose of the present invention is to provide the end cap of a flat wiper blade apparatus, which can be assembled to the flat blade in the vertical direction, that is to say, in the up and down direction, and is to provide the flat wiper blade apparatus.

However, the object of the present invention is not limited to the above description and can be variously extended without departing from the scope and spirit of the present invention.

### Technical Solution

To accomplish the purpose of the present invention, one embodiment of the present invention is an end cap for a flat wiper blade apparatus. The end cap includes: a main body which has a cross section corresponding to a cross section of a spoiler member of the flat wiper blade apparatus and surrounds a portion of the spoiler member; a support member which contacts an end portion of the spoiler member and is formed inside the main body across the main body in a width direction; a hook which is formed on one side of the support member and is fastened to an opening of a spring member of the flat wiper blade apparatus; and a protrusion which protrudes from one surface of the support member and by which a portion of a wiper rubber of the flat wiper blade apparatus is caught.

The support member may have a recess for receiving the wiper rubber.

The recess may be formed in a central portion of the support member and recessed toward an inside of the main body from the support member.

The end cap for a flat wiper blade apparatus may further include a retainer which is formed at the edges of both sides of the end cap in the width direction of the main body and restrains a portion of the spoiler member.

The retainer may have a semicircular columnar shape.

Another embodiment is a flat wiper blade apparatus including: a wiper rubber which has a catching recess formed in at least one end portion thereof and comes in contact with a glass surface of a vehicle and slides; a spring member which supports the wiper rubber and has an opening in at least one end portion thereof; a spoiler member to which the wiper rubber and the spring member are assembled; and an end cap which is coupled to at least one end portion of the spoiler member. The end cap may include: a main body which has a cross section corresponding to a cross section of the spoiler member and surrounds a portion of the spoiler member; a support member which contacts an end portion of the spoiler member and is formed inside the main body across the main body in a width direction; a hook which is formed on one side of the support member and is fastened to an opening of the spring member; and a protrusion which protrudes from one surface of the support member and is caught by the catching recess.

### Advantageous Effects

According to the foregoing embodiments of the present invention, the assembly process of the end cap of the flat wiper blade apparatus can be simplified.

Also, according to the foregoing embodiments of the present invention, since the end cap can be assembled to the flat blade in the vertical direction, that is to say, in the up and down direction, the number of assembling steps can be reduced.

However, the effect of the embodiment of the present invention is not limited to the effects described above and can be variously modified without departing from the spirit and scope of the present invention.

### BRIEF DESCRIPTION OF THE DRAWINGS

FIG. 1 is a perspective view of a flat wiper blade apparatus according to an embodiment of the present invention;

FIG. 2 is an exploded perspective view of the flat wiper blade apparatus shown in FIG. 1;

FIG. 3 is a view showing the coupling relationship between an end cap and other components according to the embodiment of the present invention;

FIG. 4 is a view showing in detail the structure of the end cap according to the embodiment of the present invention. More specifically, a front view of the end cap is shown in (a) of FIG. 4, and a perspective view of the end cap is shown in (b) of FIG. 4;

FIG. 5 is a cross sectional view showing a cross section of the end cap coupled to other components of the flat wiper blade apparatus;

FIG. 6 is a view showing a wiper rubber of FIG. 2 and a spring member of FIG. 2 to which the wiper rubber has been coupled. More specifically, a perspective view of the wiper rubber is shown in (a) of FIG. 6, and a perspective view of the spring member to which the wiper rubber has been coupled is shown in (b) of FIG. 6;

FIG. 7 is a view showing a spoiler member and the end cap. More specifically, a perspective view of the end cap coupled to the spoiler member is shown in (a) of FIG. 7, and a perspective view of the end cap separated from the spoiler member is shown in (b) of FIG. 7; and

FIG. 8 is a cross sectional view of the flat wiper blade apparatus which has been cut in order to show a retainer of FIG. 5.

### DETAILED DESCRIPTION

Embodiments of the present invention will be described in detail with reference to the accompanying drawings. In the components of the present invention, detailed descriptions of what can be clearly understood and easily carried into practice through prior art by those skilled in the art will be omitted to avoid making the subject matter of the present invention unclear.

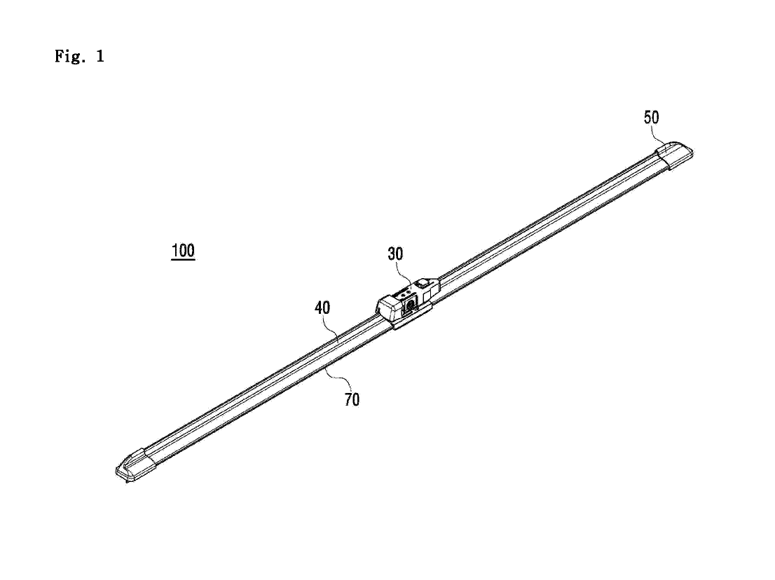

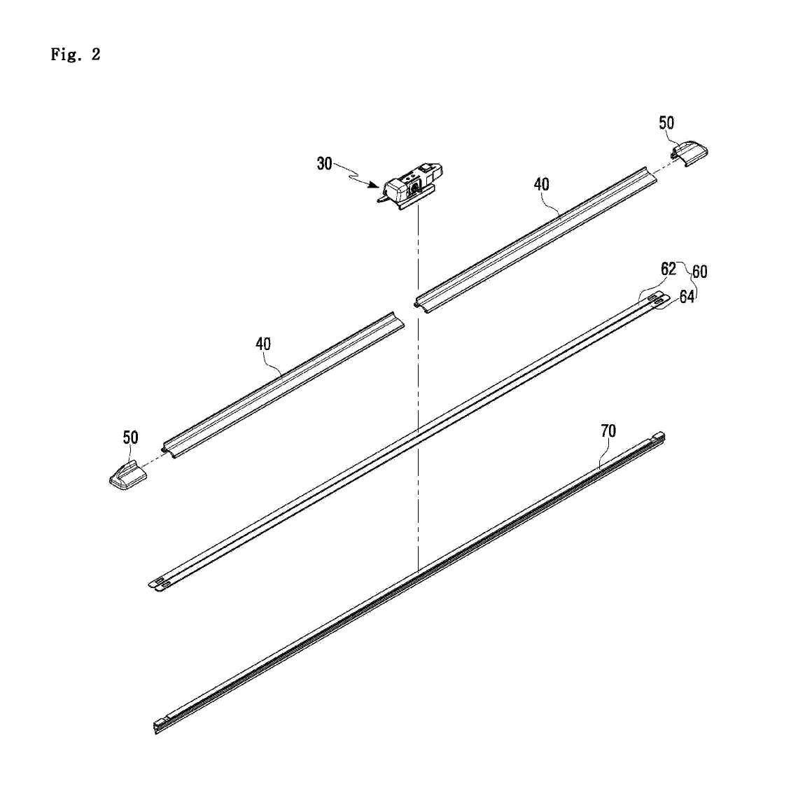

FIG. 1 is a perspective view of a flat wiper blade apparatus according to an embodiment of the present invention. FIG. 2 is an exploded perspective view of the flat wiper blade apparatus shown in FIG. 1.

Referring to FIGS. 1 and 2, a flat wiper blade apparatus 100 according to the embodiment of the present invention is installed on the windshield of a vehicle. The flat wiper blade apparatus 100 includes an adaptor 30, a spoiler member 40, a spring member 60, a wiper rubber 70, and an end cap 50.

The spring member 60 is a metal-made plate-shaped member. The spring member 60 causes the below-described wiper rubber 70 to closely contact with the glass surface of the vehicle with a certain rigidity and elasticity. The spring member 60 may be made of, for example, carbon steel stainless steel.

The adaptor 30 is disposed in the center of the spring member 60. The adaptor 30 is provided in order to mount the flat wiper blade apparatus 100 on a wiper arm (not shown). The adaptor 30 is fixed to the spring member 60. The adaptor 30 can be fixed to the spring member 60 by a caulking, welding, or snap method.

The spoiler members 40 are disposed on both sides of the adaptor 30 in such a manner that the adaptor 30 is placed between the spoiler members 40. The spoiler member 40 is slidably coupled to the spring member 60. The spoiler member 40 induces a flow of air such that the spoiler member 40 is pressed against the glass of the vehicle when the vehicle travels at a high speed. The spoiler member 40 receives the spring member 60.

The wiper rubber 70 comes in contact with the glass surface of the vehicle and slides. The wiper rubber 70 is made of an elastic rubber material. When the wiper arm is operated, the wiper rubber 70 contacts the surface of the windshield or rear glass of the vehicle and is moved to remove impurities on the surface.

The end cap 50 is provided to finish the flat wiper blade apparatus 100 in the vertical direction. Also, the end cap 50 supports the wiper rubber 70 of the flat wiper blade apparatus 100.

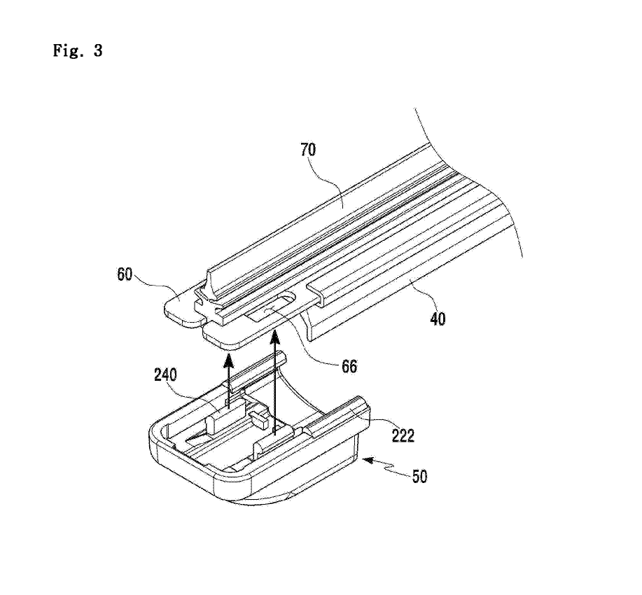

FIG. 3 is a view showing the coupling relationship between the end cap and other components according to the embodiment of the present invention.

Referring to FIG. 3, the end cap 50 is coupled to the end portion of the spoiler member 40. The spoiler member 40 is slidably coupled to the spring member 60. In other words, the spoiler member 40 is coupled to the spring member 60 in a horizontal direction. It is preferable that the end cap 50 has a shape similar to that of the spoiler member 40 because the end cap 50 finishes the end portion of the spoiler member 40. Specifically, the cross section of the end cap 50 has a shape corresponding to the cross section of the spoiler member 40.

The end cap 50 may be coupled to the spring member 60 in a vertical direction indicated by an arrow of FIG. 3. The end cap 50 may be fastened to a fastening opening 66 formed in the spring member 60. Also, the end cap 50 may be fastened to a catching recess formed in the wiper rubber 70.

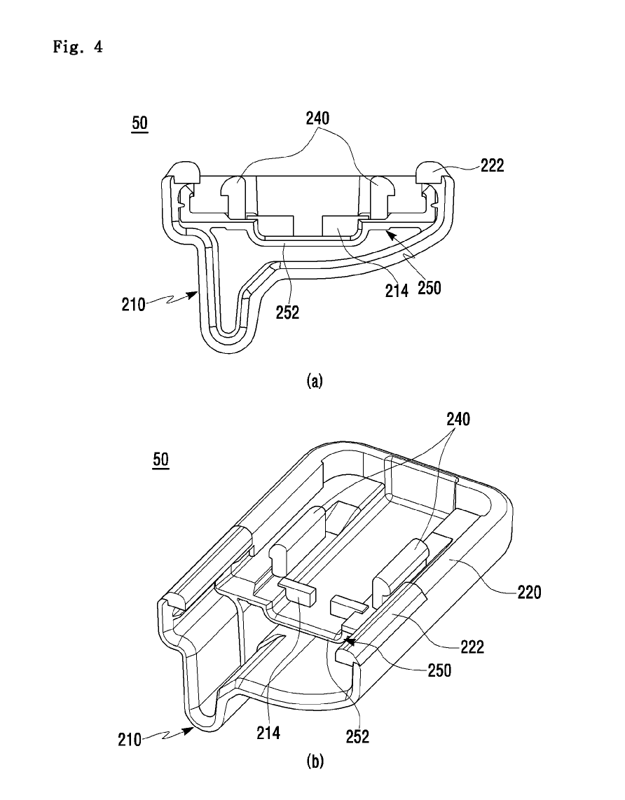

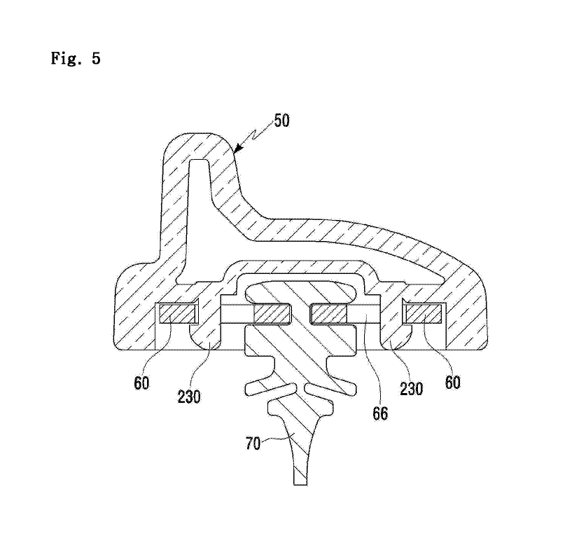

FIG. 4 is a view showing in detail the structure of the end cap according to the embodiment of the present invention. More specifically, a front view of the end cap is shown in (a) of FIG. 4, and a perspective view of the end cap is shown in (b) of FIG. 4. FIG. 5 is a cross sectional view showing a cross section of the end cap coupled to other components of the flat wiper blade apparatus.

Referring to FIGS. 4 and 5, the end cap 50 includes a main body 210 which has a cross section corresponding to the cross section of the spoiler member 40 and surrounds a portion of the spoiler member 40.

Also, the end cap 50 includes a support member 250 which contacts the end portion of the spoiler member 40 and is formed inside the main body 210 across the main body 210 in the width direction of the end cap. The support member 250 may support the spring member 60 and the wiper rubber 70.

The support member 250 has a recess 252 receiving the wiper rubber 70. Specifically, the recess 252 is formed in the central portion of the support member 250 and is recessed toward the inside of the main body 210 from the support member 250.

Also, the end cap 50 includes a hook 240 which is formed on one side of the support member 250 and is fastened to the opening 66 of the spring member 60.

The spring member 60 is seated on the support member 250. The spring member 60 is coupled to the wiper rubber 70.

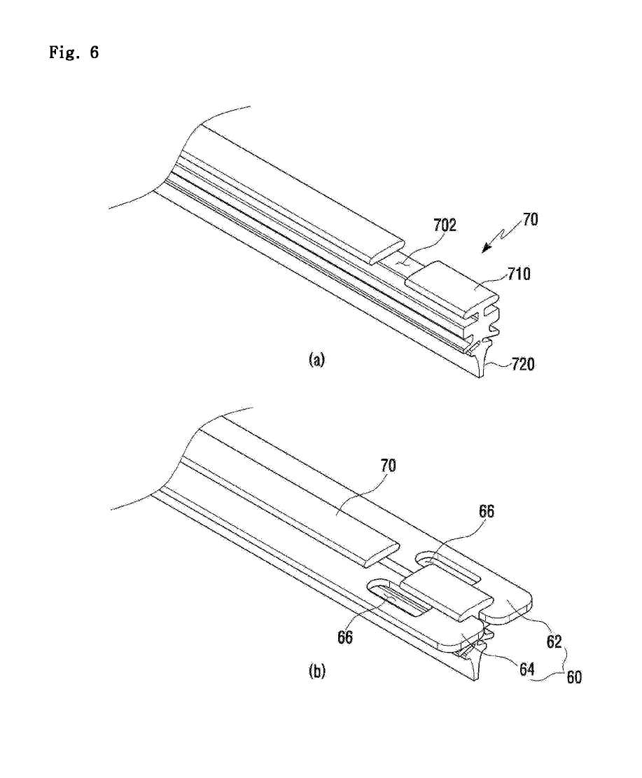

FIG. 6 is a view showing the wiper rubber 70 and the spring member 60 to which the wiper rubber has been coupled. More specifically, a perspective view of the wiper rubber 70 is shown in (a) of FIG. 6, and a perspective view of the spring member 60 to which the wiper rubber 70 has been coupled is shown in (b) of FIG. 6.

Referring to (a) of FIG. 6, the wiper rubber 70 wipes the glass window of the vehicle, especially, glass window of a car. It is desirable that the wiper rubber 70 should be made of an elastic material, particularly, rubber. The wiper rubber 70 includes a ridge portion 710 coupled to the spoiler member and includes a wiper rib 720 which contacts the glass window of the vehicle. The ridge portion 710 has a fastening groove 702 formed in one end portion of the ridge portion 710.

The spring member 60 to which the wiper rubber 70 has been coupled is shown in (b) of FIG. 6. The spring member 60 includes a first spring 62 and a second spring 64. The first and second springs 62 and 64 have the same shape. The first and second springs 62 and 64 are made of, for example, a metallic material. As described above, the first and second springs 62 and 64 cause the wiper rubber 70 to closely contact with the glass surface of the vehicle with a certain rigidity and elasticity.

The first and second springs 62 and 64 include the opening 66 in the end portion thereof respectively. The hook 240 of the end cap 50 is fastened to the opening 66.

Referring back to FIG. 4, the end cap 50 includes a protrusion 214 which protrudes from one surface of the support member 250 and by which a portion of the wiper rubber 70 is caught.

As described above, the wiper rubber 70 has the fastening groove 702 in the ridge portion 710. Hence, in the wiper rubber 70, one end portion of the ridge portion 710 is spaced apart from the remaining ridge portion 710 by the fastening groove 702. The portion of the ridge portion 710 is received in the recess 252 formed in the support member 250. The protrusion 214 of the end cap 50 is received in the fastening groove 702 of the wiper rubber 70.

Also, the end cap 50 includes a retainer 222 which is formed at the edges of both sides of the end cap in the width direction of the main body 210 and restrains a portion of the spoiler member 40. According to the embodiment, the retainer 222 has a semicircular columnar shape.

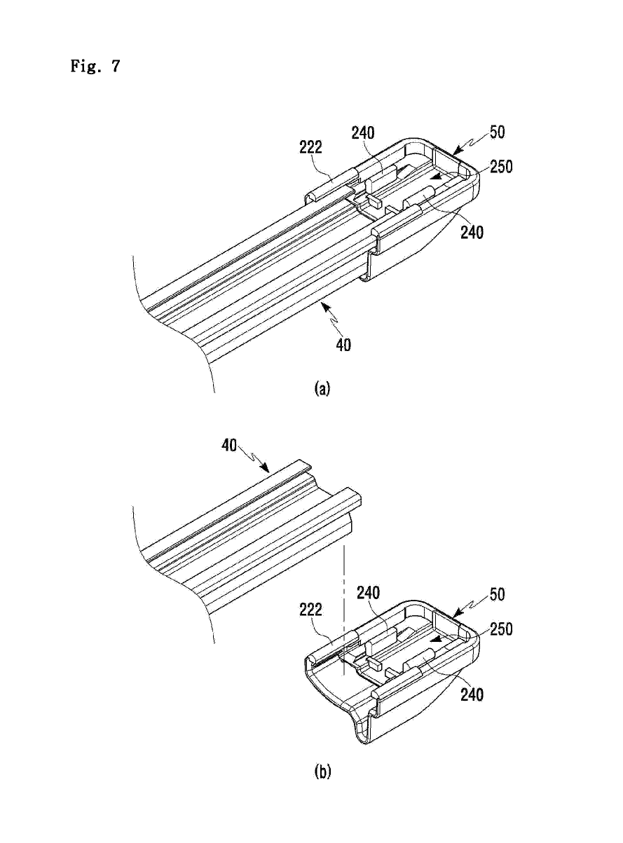

FIG. 7 is a view showing the spoiler member and the end cap. More specifically, a perspective view of the end cap coupled to the spoiler member is shown in (a) of FIG. 7, and a perspective view of the end cap separated from the spoiler member is shown in (b) of FIG. 7. In (a) and (b) of FIG. 7, for convenience of drawing, the spring member 60 and the wiper rubber 70 are not shown.

Referring to (a) and (b) of FIG. 7, the end cap 50 surrounds a portion of the spoiler member 40. The support member 250 is formed in the portion of the end cap 50 which does not surround the spoiler member 40. When the end cap 50 is coupled to the spoiler member 40, the side of the support member 250 comes in contact with the end portion of the spoiler member 40. Preferably, the cross section of the support member 250 may be formed corresponding to the cross section of the spoiler member 40.

The end cap 50 is coupled with the spoiler member 40 in the vertical direction instead of in the horizontal direction. The hook 240 which protrudes in the vertical direction is provided in the end cap 50. Therefore, when the end cap 50 is moved in the vertical direction with respect to the spoiler member 40, the spring member 60, and wiper rubber 70, the hook 240 is inserted into and caught by the fastening opening 66 of the spring member 60. Also, a space receiving one end of the spoiler member 40 is formed in the end cap 50. As shown in FIG. 7, when the end cap 50 and the spoiler member 40 are fastened to each other in the upper portion of the space, the retainer 222 may be provided on an edge 220 of the end cap 50 in order that the spoiler member 40 is not separated from the end cap 50.

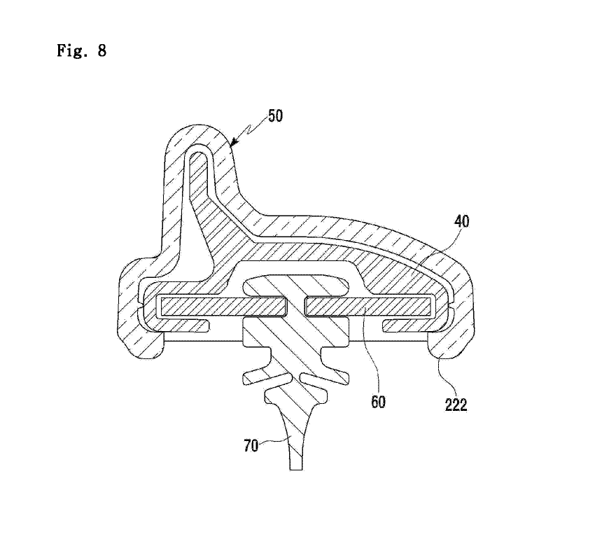

FIG. 8 is a cross sectional view of the flat wiper blade apparatus which has been cut in order to show the retainer of FIG. 5.

Referring to FIG. 8, the retainer 222 may restrain a portion of the spoiler member 40 such that the spoiler member 40 is not separated from the end cap 50. The retainer 222 is formed at the edges of both sides of the end cap in the width direction of the main body 210. When the end cap 50 is coupled to the spoiler member 40 in the vertical direction, the retainer 222 protrudes slightly from the edges 220 of the main body 210 to the inside of the end cap 50. Therefore, when the end cap 50 is pressed to the assembly of other components in the vertical direction, the end cap 50 spreads in the width direction and assembled to the assembly of other components in the vertical direction. Then, retainer 222 is able to restrain the assembly of other components.

Also, since the retainer 222 has a semicircular cross section, the end cap 50 can be easily to be smoothly assembled to the assembly of other components. Describing in more detail, when the assembly of the spoiler member 40, the spring member 60, and the wiper rubber 70 is inserted into the open side of the end cap 50, the spoiler member 40 is inserted into the open side of the end cap 50 and is pressed. Here, since the curved edge of the retainer 222 allows the spoiler member 40 to softly press the end cap 50, the end cap 50 spreads easily. After the spoiler member 40 is completely fastened to the end cap 50, the retainer 222 protrudes slightly from the edges 220 of the end cap 50 to the inside of the end cap 50 and restrains the spoiler member 40, thereby preventing the spoiler member 40 from being separated from the end cap 50.

According to the above-described embodiments of the present invention, the assembly process of the end cap of the flat wiper blade apparatus can be simplified. Also, according to the embodiments of the present invention, since the end cap can be assembled to the flat blade in the vertical direction, that is, in the up and down direction, the number of assembling steps can be reduced.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

REFERENCE NUMERALS

| | |
|---|---|
| 30: adaptor | 40: spoiler member |
| 50: end cap | 60: spring member |
| 70: wiper rubber | |

What is claimed is:

1. An end cap for a flat wiper blade apparatus, the end cap comprising:
a main body which has a cross section corresponding to a cross section of a spoiler member of the flat wiper blade apparatus and surrounds a portion of the spoiler member;
a support member which contacts an end portion of the spoiler member and is formed inside the main body across the main body in a width direction;
a hook which is formed on one side of the support member and is fastened to an opening of a spring member of the flat wiper blade apparatus; and
a protrusion which protrudes from one surface of the support member and by which a portion of a wiper rubber of the flat wiper blade apparatus is caught.

2. The end cap for a flat wiper blade apparatus of claim 1, wherein the support member has a recess for receiving the wiper rubber.

3. The end cap for a flat wiper blade apparatus of claim 2, wherein the recess is formed in a central portion of the support member and is recessed toward an inside of the main body from the support member.

4. The end cap for a flat wiper blade apparatus of claim 1, further comprising a retainer which is formed at the edges of both sides of the end cap in the width direction of the main body and restrains a portion of the spoiler member.

5. The end cap for a flat wiper blade apparatus of claim 4, wherein the retainer has a semicircular columnar shape.

6. A flat wiper blade apparatus comprising:
a wiper rubber which has a catching recess formed in at least one end portion thereof and comes in contact with a glass surface of a vehicle and slides;
a spring member which supports the wiper rubber and has an opening in at least one end portion thereof;
a spoiler member to which the wiper rubber and the spring member are assembled; and
an end cap which is coupled to at least one end portion of the spoiler member,
wherein the end cap comprises:
a main body which has a cross section corresponding to a cross section of the spoiler member and surrounds a portion of the spoiler member;
a support member which contacts an end portion of the spoiler member and is formed inside the main body across the main body in a width direction;
a hook which is formed on one side of the support member and is fastened to an opening of the spring member; and
a protrusion which protrudes from one surface of the support member and is caught by the catching recess.

7. The flat wiper blade apparatus of claim 6, wherein the support member has a recess for receiving the wiper rubber.

8. The flat wiper blade apparatus of claim 7, wherein the recess is formed in a central portion of the support member and is recessed toward an inside of the main body from the support member.

9. The flat wiper blade apparatus of claim 6, further comprising a retainer which is formed at the edges of both sides of the end cap in the width direction of the main body and restrains a portion of the spoiler member.

10. The flat wiper blade apparatus of claim 9, wherein the retainer has a semicircular columnar shape.
